(19) United States
(12) Patent Application Publication
(10) Pub. No.: US 2005/0035158 A1
(43) Pub. Date: Feb. 17, 2005

(54) Closure

(76) Inventors: Claude Jean Benoit-Gonin, Odenas (FR); Philippe Aime Bardet, Gleize (FR)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/497,247

(22) PCT Filed: Nov. 27, 2002
(86) PCT No.: PCT/EP02/13370

(30) Foreign Application Priority Data
Nov. 30, 2001 (EP) 01310088.8

(51) Int. Cl. B67D 3/00

(52) U.S. Cl. 222/564

(57) ABSTRACT

A closure (20) for a container (10) is provided and includes a base (30) connectable to the mouth of the container (10) and a spout (37). The closure (20) further includes a baffle member (43) which, in use, is disposed in the flow path between the mouth of the container (10) and the spout (37).

The present invention relates generally to a closure for a container and specifically to a closure having some means of regulating the flow of fluid out of the container.

It is well known to provide closures with a spout, lip or the like which is associated with the point of exit of fluid from a container in order to control the fluid flow path. In many cases, and particularly where larger volumes of fluid are concerned, the function of the spout is primarily to direct the fluid into a thin stream to aid dispensing. However, the spout does not have an effect on the flow characteristics of the fluid as it leaves the container and approaches the spout, so that if the flow of fluid is turbulent as it passes from the container through the body of the closure to the spout then, whilst the presence of the spout assists in directing the fluid, the fluid will not be poured smoothly.

Additionally, U.S. Pat. No. 5,785,209 describes a closure having a pourer which comprises flow rate regularising means in the form of a cruciform.

EP 0 416 694 on the other hand describes a drop dispensing tip having a convoluted delivery path to control drop size and to prevent streaming.

Accordingly, the present invention provides a closure for a container, comprising a base connectable to the mouth of the container, a lid, a spout and a baffle arrangement which in use of the closure is disposed in the flow path between the mouth of the container and the spout, characterised in that at least part of the baffle arrangement is carried on or by the lid.

The present invention is therefore concerned with the path of the fluid between the mouth of the container and the final exit point of the fluid from the closure. The use of some form of baffle member or baffle arrangement between the mouth of the container and the spout increases the length of the fluid path and helps to prevent turbulent flow. The closure also has a lid to prevent the ingress of contaminants into the container, and at least part of the baffle arrangement is carried on or by the lid.

In many cases, lids of plastic closures include an inner skirt to seal the opening of the container reliably. In the present invention an inner skirt is used not only as a sealing member but also as a baffle member.

The closure lid may be connected to the body by a hinge. The hinging of the lid may be restricted so that in the open position the baffle is positioned as required in the flow path. It is not essential that the body and the lid are permanently connected nor that the baffle is an integral part of the closure, merely that in the dispensing position the baffle is appropriately positioned in the fluid flow path between the mouth of the container and the spout.

The closure base may include a frustoconical portion which defines a restricted opening leading from the mouth of the container. The frustoconical portion may comprise or form at least part of the baffle arrangement. The inclined walls of a frustoconical portion allow for an inner skirt which depends from a lid to seal around the base of the portion. Either by itself or together with a further baffle member the frustoconical portion can be used to regulate the fluid flow regulation before or as it leaves the restricted opening and passes towards the spout.

By having a baffle member which depends from the lid the baffle member can extend across the entire width of the opening and therefore restrict the fluid to a single path under its lower surface. A baffle member which depends from a lid forces a downward component of movement into the fluid in the flow path.

If a baffle member is to have an appreciable effect it must be positioned in the fluid flow path to the extent that it has an effect on as much of the flow path as possible. A baffle member which upstands from the closure body adjacent the opening from the mouth of the container could therefore extend for the full height of the fluid flow path, but not its full width, to direct the flow laterally.

Of course there is no reason why more than one baffle member could not be used and a labyrinthine flow path created which may have further beneficial effects, in particular for very large volumes of fluid where the pressure and the flow rate out of the closure is affected by the weight of the fluid above it.

The baffle member may be arranged so that the fluid path from the mouth of the container to the spout is sinusoidal. As discussed above the sinusoidal path could be laterally extending or axially extending, depending on the arrangement of the baffle member, the container mouth and the spout.

The closure may further comprise an air vent to serve as an anti-glugging feature, which will further help to reduce turbulent flow.

It is also possible that the baffle member may be multi-partite with, for example, part of the baffle member being carried on the body and part carried on the lid, assembly of the baffle member into the fluid flow path being effected by the opening of the lid.

The closure may further include a weir member which is disposed in the flow path at a point upstream of the baffle member. The baffle member thereby forms part of a regulatory arrangement including a plurality of regulatory surfaces.

The present invention will now be more particularly described, by way of example, with reference to the accompanying drawings, in which:

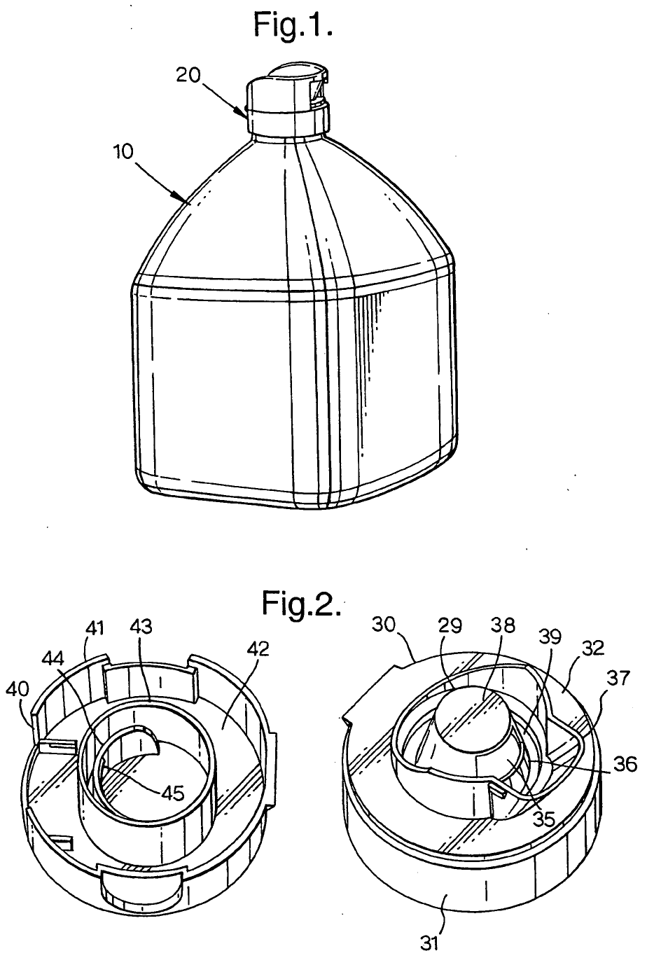

FIG. 1 shows a container fitted with a closure according to the present invention;

FIG. 2 is a perspective view of a base and a lid which together form the closure of FIG. 1;

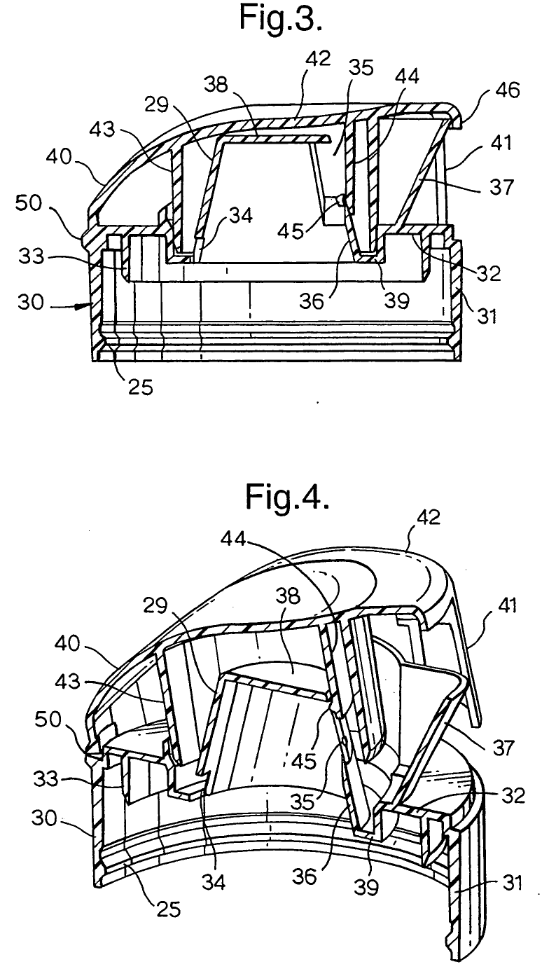

FIG. 3 is a section through the closure of FIG. 2 shown in a closed position; and

FIG. 4 is a perspective view of the closure of FIG. 3 shown in an open, dispensing position.

Referring first to FIG. 1 there is shown a container 10, which in this embodiment is a five litre plastic bottle such as that used for holding mineral water or the like. The container 10 is provided with a closure generally indicated 20 which include means for regulating the flow of material from the container as described in more detail below.

Referring now to FIGS. 2 to 4, the closure 20 comprises a base 30 and a lid 40.

The base 30 comprises a cylindrical outer skirt 31 which depends from a top annulus 32. A shorter inner skirt 33 also depends from the annulus 32 and is used together with a snap bead 25 on the skirt 31 to connect the base 30 to the mouth of a container. The annulus 32 carries at its centre a hollow frustoconical portion 29 which tapers axially from its lower end which is connected to the annulus 32, to a roof 38.

The lower end of the frustoconical portion includes an air vent 34 for allowing air into the container as material escapes. A restricted opening 35 is defined towards the upper end of the frustoconical portion; and the section of the frustoconical portion 29 below the opening 35 provides a weir member 36, the purpose of which is described in more detail below. The remainder of the portion 29 could itself be considered as a baffle member. In embodiments where there is no separate baffle member, the portion 29 including its weir member 36 can represent the baffle arrangement.

The annulus 34 carries, at the point radially outside and in line with the opening 35, a spout 37. The frustoconical portion 29 is joined to the annulus 32 by a generally L-shaped (in section) ring 39 which thereby defines a channel between the annulus 32 and the frustoconical portion 29.

The lid 40 comprises a cylindrical skirt 41 closed at one end by a top plate 42. An inner skirt 43 depends from the top plate 42. Radially inwardly of the inner skirt 43 a semi-circular wall 44 depends from the top plate. The length of the skirt 41 is continuous around its circumference except for a cut-out portion which defines a rim 46. A lug 45 protrudes radially inwardly from the lower end of the wall 44.

Referring now in particular to FIG. 3, the lid 40 and base 30 are shown connected to each other by a film hinge 50. In this closed position the inner skirt 43 of the lid 40 extends into the channel 39 of the base 30. This type of arrangement is known for sealing lids to base members. The position of the wall 44 is such that it lies in the region of the opening, and the lug rests on the bottom of the opening, being of such dimension that it can fit into the opening. The cut out portion of the skirt 41 of the lid 40 allows the lid 40 to pass over the spout 37, and the rim 46 closes over the spout so that it is covered.

Referring now in particular to FIG. 4, in which the closure has been moved to an open, dispensing position. The hinged movement of the lid 40 with respect to the base 30 is limited to the extent shown because the lug 45 engages under the roof 38 of the frustoconical portion 33. In use water leaves the container through the container mouth and approaches the closure. The first surface that the water encounters is the weir member 36. The water is prevented from passing directly to the spout 37 because of the skirt 43. In the open position the skirt 43 of the lid 40 is positioned slightly radially outwardly of the opening and in line therewith. Because of the presence of the skirt 43 the water is now directed into the channel before it can flow along the surface of the spout 37. In this embodiment therefore the skirt 43 acts as a baffle member which, together with the weir member 36 increases the length of the flow path and thereby increases the amount of time the water flow has to approach a linear, and therefore less turbulent flow.

1. A closure for a container, comprising a base connectable to the mouth of a container, a lid, a spout, and a baffle arrangement, wherein, during use of the closure the baffle is disposed in the flow path between the mouth of the container and the spout wherein at least part of the baffle arrangement is carried on or by the lid.

2. A closure as claimed in claim 1, wherein the movement of the lid is restricted so as to position baffle arrangement in the flow path.

3. A closure as claimed in claim 1, wherein the lid comprises a top plate with a skirt depending therefrom and a lug protrudes radially inwardly from the skirt to restrict the movement of the lid.

4. A closure as claimed in claim 1, wherein the lid is connected to the body by a hinge.

5. A closure as claimed in claim 1, wherein the closure further comprises a weir member disposed in the flow path at a point upstream of the baffle member.

6. A closure as claimed in claim 1, wherein the base includes a frustoconical portion defining a restricted opening.

7. A closure as claimed in claim 1, wherein the closure further comprises an air vent.

8. A closure as claimed in claim 1, wherein the baffle arrangement is arranged so that the fluid path from the mouth of the container to the spout is sinusoidal.
